(19) United States
(12) Patent Application Publication
(10) Pub. No.: US 2026/0282153 A1
(43) Pub. Date: Sep. 17, 2026

(54) AI/ML CONTROL METHOD AND APPARATUS

(71) Applicant: 1FINITY Inc., Kawasaki-shi (JP)

(72) Inventors: Guotong WANG, Beijing (CN); Xin WANG, Beijing (CN); Qun ZHANG, Beijing (CN)

(73) Assignee: 1FINITY Inc., Kawasaki-shi (JP)

(21) Appl. No.: 19/666,898

(22) Filed: May 4, 2026

Related U.S. Application Data
(63) Continuation of application No. PCT/CN2023/132427, filed on Nov. 17, 2023.

(51) Int. Cl. H04W 76/20; H04L 5/00; H04L 41/16; H04W 72/231; H04W 72/51

(52) U.S. Cl. CPC H04W 76/20; H04L 5/0053; H04L 41/16; H04W 72/231; H04W 72/51

(57) ABSTRACT

An AI/ML control apparatus, configured in a terminal equipment, includes: a transmitter configured to report information on one or more applicable or preferred or selected or candidate or recommend AI/ML functionalities/models to a network device via a radio resource control (RRC) message, wherein the radio resource control (RRC) message is a RRC reconfiguration complete message or a UE assistance information (UAI) message.

### CROSS-REFERENCE TO RELATED APPLICATION

This application is a continuation application under 35 U.S.C. 111(a) of International Patent Application PCT/CN2023/132427 filed on Nov. 17, 2023, and designated the U.S., the entire contents of which are incorporated herein by reference.

### TECHNICAL FIELD

Embodiments of this disclosure relate to the field of communication technologies.

### BACKGROUND

In NR Rel-18, an artificial intelligence/machine learning (AI/ML) for an air interface is studied. The AI/ML may be available for the following use cases: channel state information (CSI) feedback enhancement, beam management, and positioning enhancement. The CSI feedback enhancement may include CSI prediction and CSI compression; the beam management may include spatial beam prediction and temporal beam prediction; and the positioning enhancement may include direct positioning and AI/ML-assisted positioning.

In some sub-use cases, a bilateral model may be used, that is, an AI/ML model is at a terminal equipment side and at a network device side. For example, the CSI compression may be used as a representative use case of the bilateral model. In other sub-use cases, a unilateral model may be used, that is, the AI/ML model is at the terminal equipment side or at the network device side.

It should be noted that the above introduction to the background is merely provided for clear and complete explanation of technical solutions of this disclosure and for easy understanding by those skilled in the art. And it should not be understood that these technical solutions are known to those skilled in the art only because they are described in the background of this disclosure.

### SUMMARY

The inventors found that there is currently no specific solution for controlling activation/deactivation/switching/fallback of an AI/ML functionality/model.

In view of at least one of the above problems, embodiments of this disclosure provide an AI/ML control method and apparatus.

According to one aspect of the embodiments of this disclosure, there is provided an AI/ML control method, including:
receiving, by a terminal equipment, indication information for indicating activation/deactivation/switching/fallback of an AI/ML functionality/model transmitted by a network device; and/or
reporting, by the terminal equipment, to the network device reporting information for determining activation/deactivation/switching/fallback of an AI/ML functionality/model.

According to another aspect of the embodiments of this disclosure, there is provided an AI/ML control apparatus, including:
a receiving unit configured to receive indication information for indicating activation/deactivation/switching/fallback of an AI/ML functionality/model transmitted by a network device; and/or
a transmitting unit configured to report to the network device reporting information for determining activation/deactivation/switching/fallback of an AI/ML functionality/model.

According to another aspect of the embodiments of this disclosure, there is provided an AI/ML control method, including:
transmitting, by a network device, to a terminal equipment indication information for indicating activation/deactivation/switching/fallback of an AI/ML functionality/model; and/or
receiving, by the network device, reporting information for determining activation/deactivation/switching/fallback of an AI/ML functionality/model reported by the terminal equipment.

According to another aspect of the embodiments of this disclosure, there is provided an AI/ML control apparatus, including:
a transmitting unit configured to transmit to a terminal equipment indication information for indicating activation/deactivation/switching/fallback of an AI/ML functionality/model; and/or
a receiving unit configured to receive reporting information for determining activation/deactivation/switching/fallback of an AI/ML functionality/model reported by the terminal equipment.

According to another aspect of the embodiments of this disclosure, there is provided a communication system, including:
a terminal equipment configured to receive indication information for indicating activation/deactivation/switching/fallback of an AI/ML functionality/model transmitted by a network device, and/or report to the network device reporting information for determining activation/deactivation/switching/fallback of an AI/ML functionality/model.

One of advantageous effects of the embodiments of this disclosure is that activation/deactivation/switching/fallback of an AI/ML functionality/model is able to be agreed upon between a network device and a terminal equipment, thereby improving accuracy and reliability of the AI/ML.

With reference to the following description and drawings, the particular embodiments of this disclosure are disclosed in detail, and the manners in which the principle of this disclosure can be used are indicated. It should be understood that the scope of the embodiments of this disclosure is not limited thereto. The embodiments of this disclosure contain a plurality of alternations, amendments and equivalents within the spirit and the scope of the terms of the appended claims.

Features that are described and/or illustrated with respect to one embodiment may be used in a same way or in a similar way in one or more other embodiments, in combination with or instead of the features of the other embodiments.

It should be emphasized that the term “comprise/include” when used herein refers to the presence of features, integers, steps or components, but does not preclude the presence or addition of one or more other features, integers, steps or components.

### BRIEF DESCRIPTION OF THE DRAWINGS

Elements and features depicted in one drawing or embodiment of this disclosure may be combined with elements and features depicted in one or more additional drawings or embodiments. Moreover, in the drawings, similar reference numerals designate corresponding parts throughout multiple drawings and may be used to designate like or similar parts in more than one embodiment.

FIG. 1 is a schematic diagram illustrating a communication system according to embodiments of this disclosure;

FIG. 2 is a schematic diagram illustrating an AI/ML control method according to embodiments of this disclosure;

FIG. 3 is another schematic diagram illustrating the AI/ML control method according to embodiments of this disclosure;

FIG. 4 is an example diagram illustrating an indication by a MAC CE according to embodiments of this disclosure;

FIG. 5 is an example diagram illustrating an indication by DCI according to embodiments of this disclosure;

FIG. 6 is an example diagram illustrating RRC+MAC CE+DCI according to embodiments of this disclosure;

FIG. 7 is an example diagram illustrating RRC+DCI according to embodiments of this disclosure;

FIG. 8 is another schematic diagram illustrating the AI/ML control method according to embodiments of this disclosure;

FIG. 9 is an example diagram illustrating a terminal equipment determination and a network device acknowledgement according to embodiments of this disclosure;

FIG. 10 is an example diagram illustrating a network device determination and a terminal equipment acknowledgement according to embodiments of this disclosure;

FIG. 11 is another schematic diagram illustrating the AI/ML control method according to embodiments of this disclosure;

FIG. 12 is a schematic diagram illustrating an AI/ML control apparatus according to embodiments of this disclosure;

FIG. 13 is another schematic diagram illustrating the AI/ML control apparatus according to embodiments of this disclosure;

FIG. 14 is a schematic diagram illustrating a terminal equipment according to embodiments of this disclosure; and

FIG. 15 is a schematic diagram illustrating a network device according to embodiments of this disclosure.

### DETAILED DESCRIPTION

The above and other features of this disclosure will be apparent with reference to the following description and drawings. In the description and drawings, particular embodiments of this disclosure have been disclosed in detail as being indicative of some of the embodiments in which the principles of this disclosure may be employed, however, it should be understood that this disclosure is not limited to the embodiments described herein. Rather, this disclosure includes all amendments, variants and equivalents falling within the scope of the appended claims.

In embodiments of this disclosure, terms “first”, “second”, etc. are used to differentiate different elements with respect to names, and do not indicate spatial arrangement or temporal orders of these elements, and these elements should not be limited by these terms. Terms “and/or” includes any one and all combinations of one or more relevantly listed terms. Terms “comprising”, “including”, “having” refer to presence of stated features, elements, components, or assemblies, but do not exclude presence or addition of one or more other features, elements, components, or assemblies.

In embodiments of this disclosure, singular forms “a”, “the”, etc., include plural forms, and should be understood as “a kind of” or “a type of” in a broad sense, but should not be limited to a meaning of “one”; and the term “the” should be understood as including both a singular form and a plural form, except clearly specified otherwise. Furthermore, the term “according to” should be understood as “at least partially according to . . . ”, the term “based on” should be understood as “at least partially based on . . . ”, except clearly specified otherwise.

In embodiments of this disclosure, the term “communication network” or “wireless communication network” may refer to a network satisfying any one of communication standards, such as Long Term Evolution (LTE), Long Term Evolution-Advanced (LTE-A), Wideband Code Division Multiple Access (WCDMA), and High-Speed Packet Access (HSPA), etc.

Furthermore, communication between devices in a communication system may be performed according to communication protocols at any stage, which may, for example, include but not limited to the communication protocols: 1G (generation), 2G, 2.5G, 2.75G, 3G, 4G, 4.5G, and 5G, New Radio (NR) and 6G in the future, etc., and/or other communication protocols that are currently known or will be developed in the future.

In embodiments of this disclosure, the term “network device”, for example, refers to a device in a communication system that accesses a terminal equipment to a communication network and provides services for the terminal equipment. The network device may include but not limited to devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), an IAB host, etc. Furthermore, the base station may include a remote radio head (RRH), a remote radio unit (RRU), a relay, or a low-power node (such as a femto, and a pico, etc.). And the term “base station” may include some or all of its functions, and each base station may provide communication coverage for a specific geographic area. And a term “cell” may refer to a base station and/or its coverage area, depending on a context in which the term is used.

In embodiments of this disclosure, the term “user equipment” (UE) or “terminal equipment or terminal device” (TE) refers to, for example, equipment accessing to a communication network and receiving network services via a network device. The terminal equipment may be fixed or mobile, and may also be referred to as a mobile station (MS), a terminal, a subscriber station (SS), an access terminal (AT), a station, etc.

The terminal equipment may include but not limited to devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, the terminal equipment may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or include one or more network devices described above. The term “user side” or “terminal side” or “terminal equipment side” refers to a side of a user or a terminal, which may be a UE, or may include one or more terminal equipments described above. “A device” in this text may refer to a network device, and may also refer to a terminal equipment, except otherwise specified.

Scenarios of embodiments in this disclosure shall be described below by way of examples. However, this disclosure is not limited thereto.

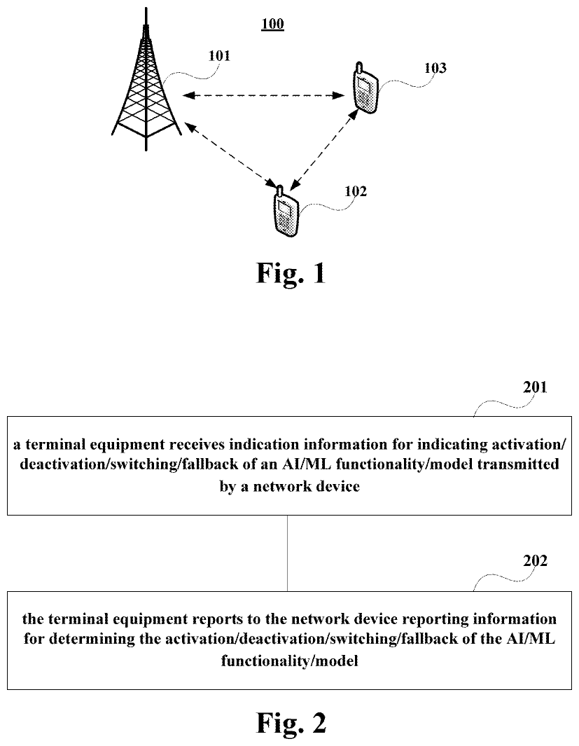

FIG. 1 is a schematic diagram illustrating a communication system according to an embodiment of this disclosure, which schematically illustrates a situation in which a terminal equipment and a network device are used as an example. As illustrated in the FIG. 1, a communication system 100 may include a network device 101 and terminal equipments 102 and 103. For the sake of simplicity, the FIG. 1 only illustrates two terminal equipments and one network device as an example, however, the embodiments of this disclosure are not limited thereto.

In embodiments of this disclosure, existing services or services that may be implemented in the future may be transmitted between the network device 101 and the terminal equipments 102 and 103. For example, these services may include but are not limited to: enhanced mobile broadband (eMBB), massive machine type communication (mMTC), and ultra-reliable and low-latency communication (URLLC), etc.

It should be noted that the FIG. 1 illustrates that both the terminal equipments 102 and 103 fall within a coverage of the network device 101, however, this disclosure is not limited thereto. Both the terminal equipments 102 and 103 may not fall within the coverage of the network device 101, or one terminal equipment 102 falls within the coverage of the network device 101 and the other terminal equipment 103 falls out of the coverage of the network device 101.

In embodiments of this disclosure, higher layer signaling may be, for example, radio resource control (RRC) signaling; for example, an RRC message, including, for example, a MIB, system information, a dedicated RRC message; or an RRC IE (RRC information element). The higher layer signaling may also be, for example, MAC (Medium Access Control) signaling; or a MAC CE (MAC control element). However, this disclosure is not limited thereto.

In embodiments of this disclosure, one or more AI/ML models may be configured and run in a network device and/or a terminal equipment. The AI/ML model may be used for various signal processing functions of wireless communications, such as CSI prediction, CSI compression, beam prediction, positioning management. This disclosure is not limited thereto. In addition, “/” in this disclosure represents “and/or” or represents an alternative.

### Embodiments of a First Aspect

The embodiments of this disclosure provide an AI/ML control method described from a terminal equipment side.

FIG. 2 is a schematic diagram illustrating an AI/ML control method according to an embodiment of this disclosure. As illustrated in the FIG. 2, the method includes:
201: a terminal equipment receives indication information for indicating activation/deactivation/switching/fallback of an AI/ML functionality/model transmitted by a network device; and/or
202: the terminal equipment reports to the network device reporting information for determining the activation/deactivation/switching/fallback of the AI/ML functionality/model.

It should be noted that the FIG. 2 only schematically illustrates the embodiments of this disclosure, however, this disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 2.

In some embodiments, functionality refers to an AI/ML feature/feature group enabled by a configuration, in which the configuration is supported based on conditions indicated by UE capabilities.

For example, the AL/ML functionality may be one or more functionalities, or may be one or more logical models, or may be one or more sub-functionalities, or may be one or more features, or may be one or more feature groups.

For another example, the functionality may involve use of an AI/ML for spatial beam prediction, or use of the AI/ML for temporal beam prediction, or use of the AI/ML for CSI prediction, or use of the AI/ML for direct positioning, or use of the AI/ML for assisted positioning, etc.

In some embodiments, indication information including activation/deactivation/ switching/fallback of one or more AI/ML functionalities/models is transmitted by the network device to the terminal equipment.

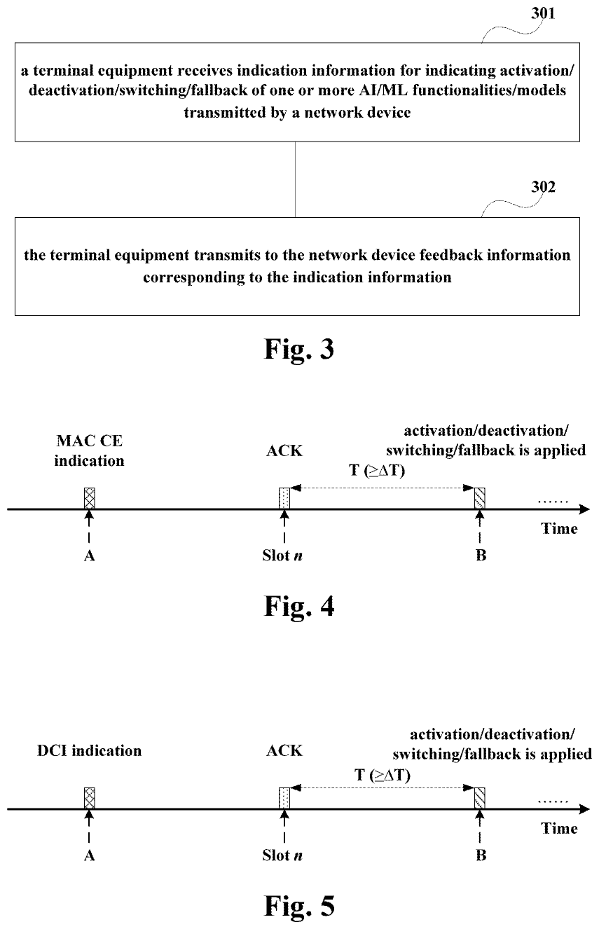

FIG. 3 is another schematic diagram illustrating an AI/ML control method according to an embodiment of this disclosure. As illustrated in the FIG. 3, the method includes:
301: a terminal equipment receives indication information for indicating activation/deactivation/switching/fallback of one or more AI/ML functionalities/models transmitted by a network device; and
302: the terminal equipment transmits to the network device feedback information corresponding to the indication information.

It should be noted that the FIG. 3 only schematically illustrates the embodiments of this disclosure, however, this disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 3.

In some embodiments, the indication information is carried by a MAC CE.

For example, activation/deactivation/switching/fallback of one or more AI/ML functionalities/models may be performed by the MAC CE, and the network device may indicate the terminal equipment to perform the activation/deactivation/switching/fallback of the one or more AI/ML functionalities/models by the MAC CE. For example, the MAC-CE may be newly defined, or an existing MAC CE may be reused.

In some embodiments, a set of AI/ML functionalities/models is configured by radio resource control (RRC), and the MAC CE indicates activation/deactivation/switching/fallback of one or more AI/ML functionalities/models in the configured set of AI/ML functionalities/models.

For example, a gNB may configure a group/list of AI/ML functionalities/models via RRC signaling. Subsequently, the gNB may indicate activation/deactivation/switching/fallback of one or more AI/ML functionalities/models in the group/list configured by the RRC by the MAC CE.

In some embodiments, the terminal equipment transmits an ACK corresponding to PDSCH to the network device in a slot n after receiving a PDSCH carrying the MAC CE, wherein activation/deactivation/switching/fallback of the AI/ML functionality/model is applied or taken into effect in a first slot after n+ΔT, where the ΔT is a predefined value or a configured value or depends on terminal capabilities. In addition, the ΔT may also include preparation time or interruption time required for the terminal equipment to perform functionality/model switching.

FIG. 4 is an example diagram illustrating an indication by a MAC CE according to an embodiment of this disclosure. As illustrated in the FIG. 4, a UE receives a MAC CE in a slot (as illustrated in A in the FIG. 4), and the UE transmits a HARQ-ACK (feedback information) in a slot n corresponding to PDSCH carrying the MAC CE. The MAC CE indicates activation/deactivation/switching/fallback of one or more AI/ML functionalities/models.

As illustrated in the FIG. 4, for example, the activation/deactivation/switching/fallback indicated by the MAC CE is applied starting from a first slot after n+ΔT (as illustrated in B in the FIG. 4). The T is greater than or equal to the ΔT, where the ΔT may be predefined or configurable, or depend on UE capabilities. The unit of the ΔT may be a slot, or other time units such as symbols.

In another example, the ΔT may also include preparation time/interruption time required for the UE to perform switching between functionalities/models. The preparation time/interruption time may also depend on the UE capabilities, and the value may be zero (a zero value means that no preparation time/interruption time is required for functionality/model switching).

In some embodiments, the indication information is carried by downlink control information (DCI).

For example, activation/deactivation/switching/fallback of one or more AI/ML functionalities/models may be performed by DCI, and the network device may indicate the terminal equipment to perform activation/deactivation/switching/fallback of one or more AI/ML functionalities/models by the DCI.

In some embodiments, the indication information is one field in the DCI, or an existing field in the DCI, or one or more codepoints in the DCI, or one DCI format, or DCI scrambled by one RNTI.

In some embodiments, the DCI is used to schedule PDSCH/PUSCH, or the DCI is not used to schedule PDSCH/PUSCH; the DCI is used for one or more serving cells.

For example, a new field may be added to an existing DCI format to indicate activation/deactivation/switching/fallback of one or more AI/ML functionalities/models. The DCI may be a DCI format scheduling PDSCH or PUSCH, such as a DCI format 0_1/0_2/0_3/1_1/1_2/1_3. gNB may transmit the DCI with scheduled PDSCH/PUSCH, or may transmit the DCI without scheduled PDSCH/PUSCH. The DCI indication for activation/deactivation/switching/fallback of one or more AI/ML functionalities/models may be applied to one serving cell, or may be applied to more than one serving cells. In addition, a new RNTI may be introduced, and the DCI scrambled by the new RNTI may be used for activation/deactivation/switching/fallback of one or more AI/ML functionalities/models.

For another example, an un-used field or a reserved codepoint in an existing DCI format may be reused to indicate activation/deactivation/switching/fallback of one or more AI/ML functionalities/models. In one example, the DCI may be in a DCI format that does not schedule PDSCH/PUSCH, such as a DCI format 0_1/0_2/0_3 that does not schedule PUSCH or a DCI format 1_1/1_2/1_3 that does not schedule PDSCH. The DCI indication for activation/deactivation/switching/fallback of one or more AI/ML functionalities/models may be applied to one serving cell, or may be applied to more than one serving cells. In addition, a new RNTI may be introduced, and the DCI scrambled by the new RNTI may be used for activation/deactivation/switching/fallback of one or more AI/ML functionalities/models.

For another example, a new DCI format may be introduced to indicate activation/deactivation/switching/fallback of one or more AI/ML functionalities/models. Accordingly, a corresponding new RNTI may be introduced. The DCI indication for activation/deactivation/switching/fallback of one or more AI/ML functionalities/models may be applied to one serving cell, or may be applied to more than one serving cells.

In some embodiments, the DCI is used for one or more terminal equipments.

For example, the DCI may indicate activation/deactivation/switching/fallback of one or more AI/ML functionalities/models for a plurality of UEs (i.e., a group of UEs). A new DCI format applicable to one or a group of UEs may be introduced, and a corresponding RNTI may be introduced. For example, a new DCI format 2_10 may be defined. The DCI indication for activation/deactivation/switching/fallback of one or more AI/ML functionalities/models may be applied to one serving cell, or may be applied to more than one serving cells.

In some embodiments, one or more fields in the DCI are used for validation; if the validation succeeds, the DCI is considered to be valid, or if the validation fails, the DCI is discarded.

For example, in the DCI indicating activation/deactivation/switching/fallback of one or more AI/MM functionalities/models, a combination of specific values of one or more fields may be used to validate the DCI. If the validation succeeds, the UE regards information in the DCI as a valid command. If the validation fails, the UE discards all information in the DCI. Specific values of one or more fields for validation may be predefined, e.g., MCS and NDI are specific values, respectively.

In some embodiments, the terminal equipment transmits to the network device an ACK/NACK for indicating whether the DCI is correctly received, after receiving the DCI. For example, the ACK/NACK is transmitted via PUCCH and/or PUSCH.

In some embodiments, the terminal equipment transmits an ACK corresponding to the DCI in slot n after correctly receiving the DCI; activation/deactivation/switching/fallback of the AI/ML functionality/model is applied or taken into effect in a first slot after n+ΔT, where the ΔT is a predefined value or a configured value or depends on terminal capabilities. In addition, the ΔT may also include preparation time or interruption time required for the terminal equipment to perform functionality/model switching.

FIG. 5 is an example diagram illustrating an indication by DCI according to an embodiment of this disclosure. As illustrated in the FIG. 5, a UE receives DCI in a slot (as illustrated in A in the FIG. 5), and the UE transmits a HARQ-ACK in a slot n corresponding to the DCI. The DCI indicates activation/deactivation/switching/fallback of one or more AI/ML functionalities/models.

As illustrated in the FIG. 5, for example, activation/deactivation/switching/fallback indicated by the DCI is applied starting from a first slot after n+ΔT (as illustrated in B in the FIG. 5). The T is greater than or equal to the ΔT, where the ΔT may be predefined or configurable, or depend on UE capabilities. The unit of the ΔT may be a slot, or other time units such as symbols.

In another example, the ΔT may also include preparation time/interruption time required for the UE to perform switching between functionalities/models. The preparation time/interruption time may also depend on the UE capabilities, and the value may be zero (a zero value means that no preparation time/interruption time is required for functionality/model switching).

In some embodiments, a set of AI/ML functionalities/models is configured by radio resource control (RRC), one subset of the configured set of AI/ML functionalities/models is selected by a MAC CE, and the DCI indicates activation/deactivation/switching/fallback of one or more AI/ML functionalities/models in the selected subset.

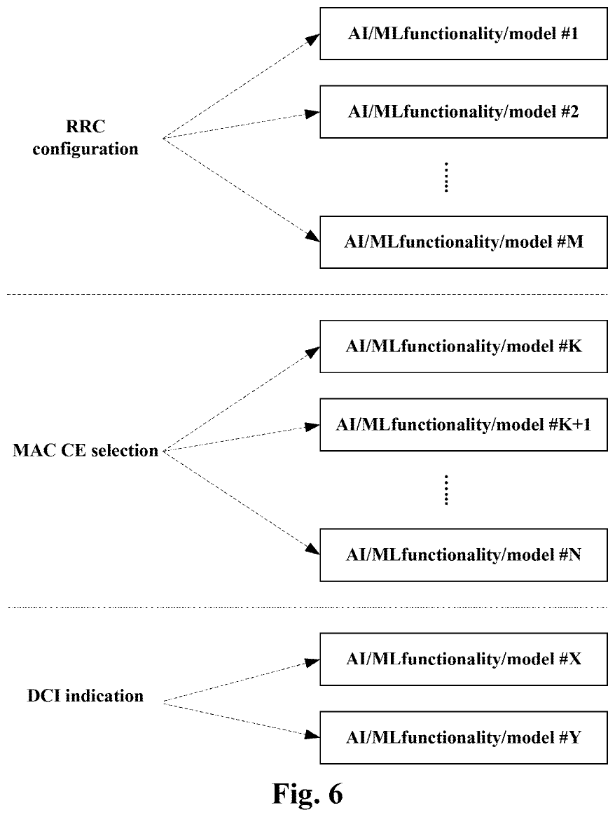

FIG. 6 is an example diagram illustrating RRC+MAC CE+DCI according to an embodiment of this disclosure. As illustrated in the FIG. 6, for example, a gNB may configure a group/list of AI/ML functionalities/models via RRC signaling, as shown by an AI/ML functionality/model #1 to an AI/ML functionality/model #M in the FIG. 6.

As illustrated in the FIG. 6, a subset of AI/ML functionalities/models may be selected by a MAC CE, as illustrated by an AI/ML functionality/model #K to an AI/ML functionality/model #N in the FIG. 6. The MAC CE may be newly defined. In one example, the MAC CE may select one or more AI/ML functionalities/models as candidate functionalities/models, and the candidate functionalities/models may be determined based on performance monitoring of the functionalities/models of the AI/ML.

As illustrated in the FIG. 6, DCI may indicate activation/deactivation/switching/fallback of one or more AI/ML functionalities/models within a subset selected by a MAC CE (such as an AI/ML functionality/model #X and an AI/ML functionality/model #Y in the FIG. 6), for example, the AI/ML functionality/model #X and the AI/ML functionality/model #Y are activated by the DCI.

In some embodiments, the subset is selected based on performance monitoring of an AI/ML functionality/model; a length of a field indicating the activation/deactivation/switching/fallback of the AI/ML functionality/model in the DCI is determined by the number of AI/ML functionalities/models in the subset selected by the MAC CE.

For example, the length of the field indicating the activation/deactivation/switching/fallback in the DCI may be determined by the number of AI/ML functionalities/models selected by the MAC CE. For example, if the number of AI/ML functionalities/models selected by the MAC CE is N, the length of the field is determined to be ┌log₂ N┐. In another example, the DCI field may be a bitmap; if the number of AI/ML functionalities/models selected by the MAC CE is N, the length of the field is N.

In some embodiments, a set of AI/ML functionalities/models is configured by radio resource control (RRC), and the DCI indicates activation/deactivation/switching/fallback of one or more AI/ML functionalities/models in the configured AI/ML functionalities/models.

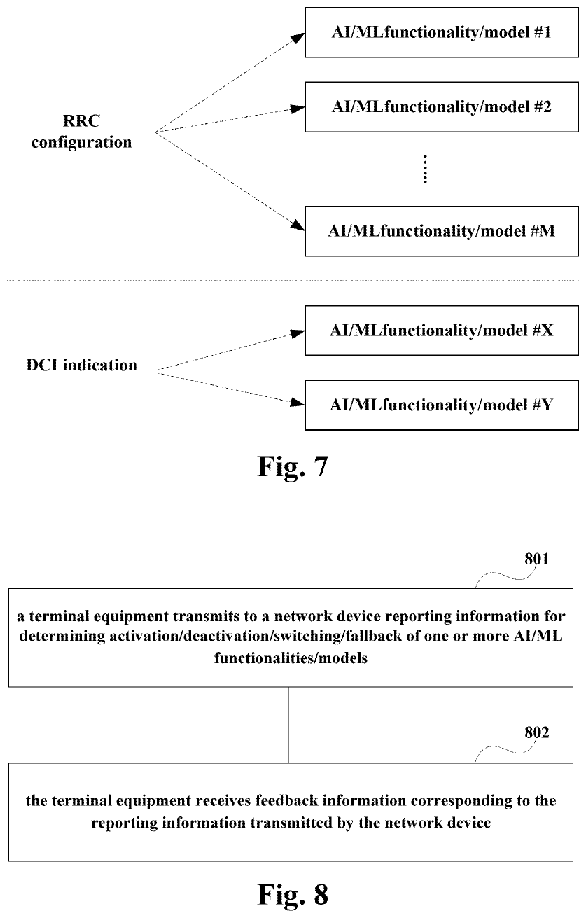

FIG. 7 is an example diagram illustrating RRC+DCI according to an embodiment of this disclosure. As illustrated in the FIG. 7, for example, a gNB may configure a group/list of AI/ML functionalities/models via RRC signaling, as illustrated by an AI/ML functionality/model #1 to an AI/ML functionality/model #M in the FIG. 7.

As illustrated in the FIG. 7, DCI may indicate activation/deactivation/switching/fallback of one or more AI/ML functionalities/models within a group/list configured by RRC (such as an AI/ML functionality/model #X and an AI/ML functionality/model #Y in the FIG. 7), for example, the AI/ML functionality/model #X and the AI/ML functionality/model #Y are activated by the DCI.

In some embodiments, a length of a field indicating activation/deactivation/switching/ fallback of the AI/ML functionality/model in the DCI is determined by the number of AI/ML functionalities/models configured by the RRC.

For example, the length of the field indicating the activation/deactivation/switching/fallback in the DCI may be determined by the number of AI/ML functionalities/models configured by the RRC. For example, if the number of AI/ML functionalities/models configured by the RRC is N, the length of the field is determined to be ┌log₂ N┐. In another example, the DCI field may be a bitmap; if the number of AI/ML functionalities/models configured by the RRC is N, the length of the field is N.

In some embodiments, the indication information is carried by radio resource control (RRC).

For example, activation/deactivation/switching/fallback of one or more AI/ML functionalities/models may be performed via RRC signaling. In a case where a corresponding RRC message is received, the activation/deactivation/switching/fallback of the one or more AI/ML functionalities/models is applied or taken into effect.

The case where activation/deactivation/switching/fallback of AI/ML functionalities/models is initiated by a network device is schematically illustrated above. A case where activation/deactivation/switching/fallback of an AI/ML functionality/model is initiated by a terminal equipment will be schematically illustrated below.

In some embodiments, reporting information including activation/deactivation/switching/fallback of one or more AI/ML functionalities/models is transmitted by the terminal equipment to the network device.

FIG. 8 is another schematic diagram illustrating an AI/ML control method according to an embodiment of this disclosure. As illustrated in the FIG. 8, the method includes:
801: a terminal equipment transmits to a network device reporting information for determining activation/deactivation/switching/fallback of one or more AI/ML functionalities/models; and
802: the terminal equipment receives feedback information corresponding to the reporting information transmitted by the network device.

It should be noted that the FIG. 8 only schematically illustrates the embodiments of this disclosure, however, this disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 8.

A case where a determination is made by a terminal equipment will be schematically illustrated below.

In some embodiments, activation/deactivation/switching/fallback of one or more AI/ML functionalities/models is determined by a terminal equipment, and the reporting information includes activation/deactivation/switching/fallback of one or more AI/ML functionalities/models determined by the terminal equipment.

For example, a UE may determine activation/deactivation/switching/fallback of one or more AI/ML functionalities/models, and may report to the network device the activation/deactivation/switching/fallback of the one or more AI/ML functionalities/models, that is, the functionalities/models are controlled at a UE side.

For example, a network side (e.g., gNB) may provide performance metrics, thresholds, performance criteria as guidance/parameter/support for determination/judgment/decision of the UE. For example, one or more of an event trigger, a performance metric, a timer, or a counter may be configured by the network device for the terminal equipment.

For another example, the determination/judgment/decision of the UE is autonomously completed by the UE, and the UE may voluntarily determine the activation/deactivation/ switching/fallback of the one or more AI/ML functionalities/models. And the UE may report to the network device for a final determination or acknowledgement.

In some examples, determination of the UE for activation/deactivation/switching/fallback of one or more AI/ML functionalities/models may be based on an event triggering, or based on functionality/model performance monitoring/evaluation, or based on a condition change. Some examples are shown below:
one or more AI/ML functionalities/models fail according to functionality/model performance monitoring;
applicable/candidated/recommended/preferred AI/ML functionalities/models are obtained or AI/ML functionalities/models are selected according to functionality/model performance monitoring;
applicable/candidated/recommended/preferred AI/ML functionalities/models are obtained or AI/ML functionalities/models are selected according to condition changes, such as scene changes, cell changes, UE speed changes, UE movement;
UE determinations are made based on hardware conditions, such as insufficient power, insufficient computing capability, overheating, insufficient memory; and
models are updated and requested to switch to a new model.

In some embodiments, the reporting information is carried by radio resource control (RRC) and/or a MAC CE and/or physical layer signaling, for example, the reporting information may be carried by any one of RRC, MAC CE, or DCI alone, or by any combination thereof.

For example, determinations of the UE for activation/deactivation/switching/fallback of one or more AI/MM functionalities/models may be reported via an RRC message. For example, the RRC message may be one of the following messages:
UAI (UEAssistanceInformation);
an RRCReconfigurationComplete message;
an RRCReestablishmentRequest message; for example, a new cause value of RestablishmentCause, such as an AI/ML functionality/model failure, or activation/deactivation/ switching/fallback of an AI/ML functionality/model, may be introduced; or
an Added RRC message.

For another example, determinations of the UE for activation/deactivation/switching/fallback of one or more AI/MM functionalities/models may be reported via a MAC CE. In one example, the MAC CE may be newly defined. In another example, an existing MAC CE may be reused.

For another example, determinations of the UE for activation/deactivation/switching/fallback of one or more AI/MM functionalities/models may be reported via physical layer signaling. The physical layer signaling may be transmitted via PRACH, PUCCH, or PUSCH. For example, the physical layer signaling may be existing UCI, or newly defined UCI may be introduced.

For another example, the reporting information may be a combination of L1 (layer 1) and L2 (layer 2) signaling, such as physical layer signaling and a MAC CE. For example, if there is no uplink resource for transmission, the UE transmits SR-like PUCCH (which may be a dedicated SR-like PUCCH resource) after one or more AI/ML functionalities/models fail. After receiving the SR-like PUCCH, the gNB may transmit DCI containing an uplink grant for PUSCH transmission, and then the UE transmits the MAC CE, which may contain information about which AI/ML functionality/model has failed or which AI/ML functionalities/models have failed.

In some embodiments, alternatively, the gNB may feedback an acknowledgement about activation/deactivation/switching/fallback of one or more AI/ML functionalities/models. The terminal equipment receives acknowledgement information fed back by the network device, wherein the acknowledgement information is carried by radio resource control (RRC) and/or a MAC CE and/or physical layer signaling.

For example, if the UE reports determinations for activation/deactivation/switching/fallback of one or more AI/MM functionalities/models, the gNB may transmit back an acknowledgement (or confirmation) via an RRC message or a MAC CE or DCI. In one example, a HARQ-ACK (corresponding to PUSCH carrying the reporting information) from the gNB may be regarded as a n acknowledgement from the gNB. In another example, an uplink grant scheduling a new transmission for a same HARQ process as the PUSCH carrying the reporting information may be regarded as an acknowledgement from the gNB.

In some embodiments, the network device transmits acknowledgement information in a slot n, wherein the activation/deactivation/switching/fallback of the AI/ML functionality/model is applied or taken into effect in a first slot after n+ΔT, where the ΔT is a predefined value or a configured value or depends on terminal capabilities. In addition, the ΔT may also include preparation time or interruption time required for the terminal equipment to perform functionality/model switching.

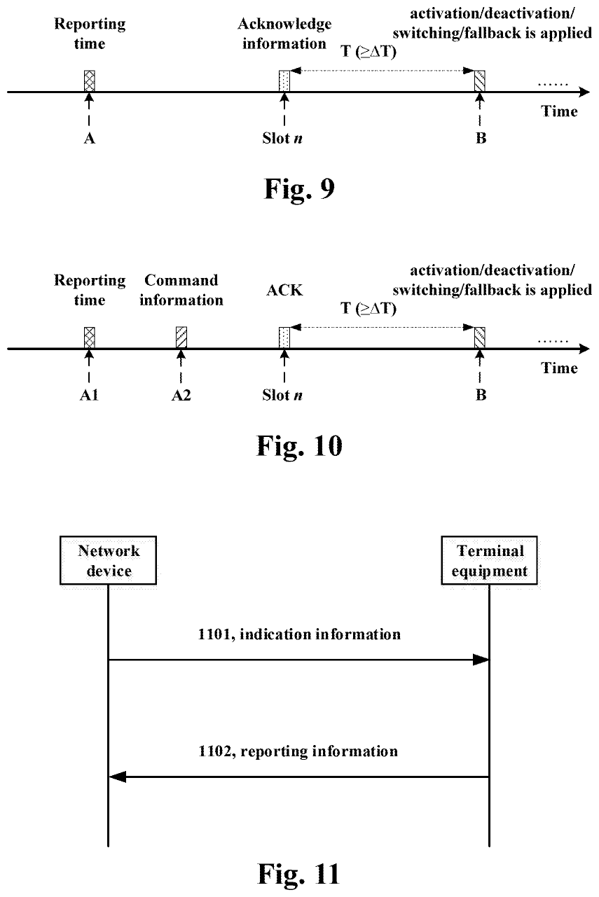

FIG. 9 is an example diagram illustrating a terminal equipment determination and a network device acknowledgement according to an embodiment of this disclosure. As illustrated in the FIG. 9, a UE transmits reporting information in a slot (as illustrated in A in the FIG. 9), and a gNB transmits acknowledgement information in a corresponding slot n. The reporting information indicates activation/deactivation/switching/fallback of one or more AI/ML functionalities/models determined by the UE.

As illustrated in the FIG. 9, for example, the activation/deactivation/switching/fallback indicated by the reporting information is applied starting from a first slot after n+ΔT (as illustrated in B in the FIG. 9). The T is greater than or equal to the ΔT, where the ΔT may be predefined or configurable, or depend on UE capabilities. The unit of the ΔT may be a slot, or other time units such as symbols.

In another example, the ΔT may also include preparation time/interruption time required for the UE to perform switching between functionalities/models. The preparation time/interruption time may also depend on the UE capabilities, and the value may be zero (a zero value means that no preparation time/interruption time is required for functionality/model switching).

A case where determinations are made by a network device will be schematically illustrated below.

In some embodiments, activation/deactivation/switching/fallback of one or more AI/ML functionalities/models is determined by the network device, and the reporting information includes activation/deactivation/switching/fallback of one or more AI/ML functionalities/models selected, candidated, recommended or preferred by the terminal equipment.

For example, a gNB may determine activation/deactivation/switching/fallback of one or more AI/ML functionalities/models, and may indicate to the terminal equipment the activation/deactivation/switching/fallback of the one or more AI/ML functionalities/models, that is, the functionalities/models are controlled at a gNB side.

In some examples, activation/deactivation/switching/fallback of one or more AI/ML functionalities/models selected or applicable or candidated or recommended or preferred by the UE may be based on an event triggering, or based on functionality/model performance monitoring/evaluation, or based on a condition change. Some examples are shown below:
one or more AI/ML functionalities/models fail according to functionality/model performance monitoring;
applicable/candidated/recommended/preferred AI/ML functionalities/models are obtained or AI/ML functionalities/models are selected according to functionality/model performance monitoring;
applicable/candidated/recommended/preferred AI/ML functionalities/models are obtained or AI/ML functionalities/models are selected according to changing conditions, such as scene changes, cell changes, UE speed changes, UE movement;
UE determinations are made based on hardware conditions, such as insufficient power, insufficient computing capability, overheating, insufficient memory; and
models are updated and requested to switch to a new model.

In some embodiments, the reporting information is carried by radio resource control (RRC) and/or a MAC CE and/or physical layer signaling, for example, the reporting information may be carried by any one of RRC, MAC CE, or DCI alone, or by any combination thereof.

For example, the UE may report activation/deactivation/switching/fallback of one or more AI/ML functionalities/models selected, applicable, candidated, recommended or preferred via an RRC message. For example, the RRC message may be one of the following messages:
UAI (UEAssistanceInformation);
an RRCReconfigurationComplete message;
an RRCReestablishmentRequest message; for example, a new cause value of RestablishmentCause, such as an AI/ML functionality/model failure, or activation/deactivation/ switching/fallback of an AI/ML functionality/model, may be introduced; or
an Added RRC message.

For another example, the UE may report activation/deactivation/switching/fallback of one or more AI/ML functionalities/models selected, applicable, candidated, recommended or preferred via a MAC CE. In one example, the MAC CE may be newly defined. In another example, an existing MAC CE may be reused.

For another example, the UE may report activation/deactivation/switching/fallback of one or more AI/ML functionalities/models selected, applicable, candidated, recommended or preferred via physical layer signaling. The physical layer signaling may be transmitted via PRACH, PUCCH or PUSCH. For example, the physical layer signaling may be existing UCI, or newly defined UCI may be introduced.

For another example, the reporting information may be a combination of L1 (layer 1) and L2 (layer 2) signaling, such as physical layer signaling and a MAC CE. For example, if there is no uplink resource for transmission, the UE transmits SR-like PUCCH (which may be a dedicated SR-like PUCCH resource) after one or more AI/ML functionalities/models fail. After receiving the SR-like PUCCH, a gNB may transmit DCI containing an uplink grant for PUSCH transmission, and then the UE transmits the MAC CE, which may contain information about which AI/ML functionality/model has failed or information about which AI/ML functionalities/models have failed.

In some embodiments, the terminal equipment receives acknowledgement information or command information fed back by the network device, wherein the acknowledgement information or command information is carried by radio resource control (RRC) and/or a MAC CE and/or physical layer signaling.

For example, if the UE reports activation/deactivation/switching/fallback of one or more AI/ML functionalities/models selected or applicable or candidated or recommended or preferred, the gNB should make a decision and transmit a command on activation/deactivation/ switching/fallback for one or more AI/ML functionalities/models. The command may be RRC or a MAC CE or DCI containing information on activation/deactivation/switching/fallback of one or more AI/ML functionalities/models.

In some embodiments, the terminal equipment transmits an ACK to the network device in a sl n, wherein the activation/deactivation/switching/fallback of the AI/ML functionality/model is applied or taken into effect in a first slot after n+ΔT, where the ΔT is a predefined value or a configured value or depends on terminal capabilities. In addition, the ΔT may also include preparation time or interruption time required for the terminal equipment to perform functionality/model switching.

FIG. 10 is an example diagram illustrating a network device determination and a terminal equipment acknowledgement according to an embodiment of this disclosure. As illustrated in the FIG. 10, a UE transmits reporting information in a slot (as illustrated in A1 in the FIG. 10), and a gNB transmits command information in another slot (as illustrated in A2 in the FIG. 10). The reporting information indicates activation/deactivation/switching/fallback of one or more AI/ML functionalities/models selected or applicable or candidated or recommended or preferred, and the command information indicates the activation/deactivation/switching/fallback of the one or more AI/ML functionalities/models determined by the gNB.

As illustrated in the FIG. 10, for example, if the UE transmits an ACK in a corresponding slot n, the activation/deactivation/switching/fallback indicated by the command information is applied starting from a first slot after n+ΔT (as illustrated in B in the FIG. 10). The T is greater than or equal to the ΔT, where the ΔT may be predefined or configurable, or depend on UE capabilities. The unit of the ΔT may be a slot, or other time units such as symbols.

In another example, the ΔT may also include preparation time/interruption time required for the UE to perform switching between functionalities/models. The preparation time/interruption time may also depend on UE capabilities, and the value may be zero (a zero value means that no preparation time/interruption time is required for functionality/model switching).

The activation/deactivation/switching/fallback of the AI/ML functionalities/models initiated by the network device and the terminal equipment are schematically illustrated above, respectively. However, this disclosure is not limited thereto.

In some embodiments, the indication information or the reporting information includes activation/deactivation/switching/fallback for an AI/ML functionality and an AI/ML model; or the indication information or the reporting information includes activation/deactivation/switching/fallback for an AI/ML functionality; or the indication information or the reporting information includes activation/deactivation/switching/fallback for an AI/ML model.

For example, activation/deactivation/switching/fallback of both AI/ML functionality and AI/ML model may be included in a signaling (an RRC message or a MAC CE or DCI) about activation/deactivation/switching/fallback of one or more AI/ML functionalities/models transmitted from the gNB side or the UE side. Alternatively, the activation/deactivation/switching/fallback of the AI/ML functionality may only be included, or the activation/deactivation/switching/fallback of the AI/ML model may only be included.

In one example, the DCI may introduce two fields, one field is used for activation/deactivation/switching/fallback of the AI/ML functionality, and another field is used for activation/deactivation/switching/fallback of the AI/ML model. Alternatively, the DCI may introduce one field for activation/deactivation/switching/fallback of the AI/ML model, and activation/deactivation/switching/fallback of the AI/ML functionality may be implicitly performed through associations between the AI/ML functionalities and the AI/ML models.

For example, one AI/ML functionality may be associated/mapped to one or more AI/ML models. For example, a gNB may be configured with one or more AI/ML functionalities to the UE, and each AI/ML functionality may be configured with one or more AI/ML models.

For another example, one AI/ML model may be associated/mapped to one or more AI/ML functionalities; for example, the functionalities are an AI/ML feature/feature group (FG) enabled by a configuration. For example, the gNB may be configured with one or more AI/ML models to the UE, and each AI/ML model may be configured with one or more AI/ML functionalities.

In embodiments of this disclosure, it may be applied to one or more or all of the following use cases (including bilateral models and unilateral models): beam management, CSI compression and CSI prediction, positioning. Options of activation/deactivation/switching/fallback of AI/ML functionalities/models in different use cases are identical, or options of activation/deactivation/switching/fallback of AI/ML functionalities/models in different use cases are different.

The above embodiments only illustrate the disclosure. However, this disclosure is not limited thereto, and appropriate variants may be made on the basis of the above embodiments. For example, the above embodiments may be used alone, or one or more of the above embodiments may be combined together.

As can be seen from the above embodiments, the activation/deactivation/switching/fallback of the AI/ML functionality/model is agreed upon between the network device and the terminal equipment, thereby improving the accuracy and reliability of the AI/ML.

### Embodiments of a Second Aspect

The embodiments of this disclosure provide an AI/ML control method described from a network device side. The embodiments of the second aspect may be combined with the embodiments of the first aspect. Same contents as those of the embodiments of the first aspect will not be described again.

FIG. 11 is another schematic diagram illustrating an AI/ML control method according to an embodiment of this disclosure. As illustrated in the FIG. 11, the method includes:
1101: a network device transmits to a terminal equipment indication information for indicating activation/deactivation/switching/fallback of an AI/ML functionality/model; and/or
1102: the network device receives reporting information for determining activation/deactivation/switching/fallback of an AI/ML functionality/model reported by the terminal equipment.

It should be noted that the FIG. 11 only schematically illustrates the embodiments of this disclosure, however, this disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 11.

In some embodiments, indication information including activation/deactivation/switching/ fallback of one or more AI/ML functionalities/models is transmitted by the network device to the terminal equipment.

In some embodiments, the indication information is carried by a MAC CE.

In some embodiments, a set of AI/ML functionalities/models is configured by radio resource control (RRC), and the MAC CE indicates activation/deactivation/switching/fallback of one or more AI/ML functionalities/models in the configured set of AI/ML functionalities/models.

In some embodiments, the terminal equipment transmits an ACK corresponding to a PDSCH to the network device in a slot n after receiving the PDSCH carrying the MAC CE.

The activation/deactivation/switching/fallback of the AI/ML functionality/model is applied or taken into effect in a first slot after n+ΔT, where the ΔT is a predefined value or a configured value or depends on terminal capabilities.

In some embodiments, the ΔT also includes preparation time or interruption time required for the terminal equipment to perform functionality/model switching.

In some embodiments, the indication information is carried by downlink control information (DCI).

In some embodiments, the indication information is one field in the DCI, or an existing field in the DCI, or one or more codepoints in the DCI, or one DCI format, or DCI scrambled by one RNTI.

In some embodiments, the DCI is used to schedule PDSCH/PUSCH, or the DCI is not used to schedule PDSCH/PUSCH;
the DCI is used for one or more serving cells.

In some embodiments, the DCI is used for one or more terminal equipments.

In some embodiments, one or more fields in the DCI are used for validation; if the validation succeeds, the DCI is considered to be valid, or if the validation fails, the DCI is discarded.

In some embodiments, the terminal equipment transmits to the network device an ACK/NACK to indicate whether the DCI is correctly received after receiving the DCI.

In some embodiments, the terminal equipment transmits an ACK corresponding to the DCI in a slot n after correctly receiving the DCI.

The activation/deactivation/switching/fallback of the AI/ML functionality/model is applied or taken into effect in a first slot after n+ΔT, where the ΔT is a predefined value or a configured value or depends on terminal capabilities.

In some embodiments, the ΔT also includes preparation time or interruption time required for the terminal equipment to perform functionality/model switching.

In some embodiments, a set of AI/ML functionalities/models is configured by radio resource control (RRC), one subset of the configured set of AI/ML functionalities/models is selected by a MAC CE, and the DCI indicates activation/deactivation/switching/fallback of one or more AI/ML functionalities/models in the selected subset.

In some embodiments, the subset is selected based on performance monitoring of the AI/ML functionality/model,
and a length of a field indicating the activation/deactivation/switching/fallback of the AI/ML functionality/model in the DCI is determined by the number of AI/ML functionalities/models in the subset selected by the MAC CE.

In some embodiments, a set of AI/ML functionalities/models is configured by radio resource control (RRC), and the DCI indicates the activation/deactivation/switching/fallback of the one or more AI/ML functionalities/models in the configured AI/ML functionalities/models.

In some embodiments, a length of a field indicating the activation/deactivation/switching/ fallback of the AI/ML functionality/model in the DCI is determined by the number of AI/ML functionalities/models configured by the RRC.

In some embodiments, the indication information is carried by radio resource control (RRC).

In some embodiments, reporting information including activation/deactivation/switching/fallback of one or more AI/ML functionalities/models is transmitted by the terminal equipment to the network device.

In some embodiments, the reporting information is carried by radio resource control (RRC) and/or a MAC CE and/or physical layer signaling.

In some embodiments, the activation/deactivation/switching/fallback of the one or more AI/ML functionalities/models is determined by the terminal equipment, and the reporting information includes the activation/deactivation/switching/fallback of the one or more AI/ML functionalities/models determined by the terminal equipment.

In some embodiments, the terminal equipment receives acknowledgement information fed back by the network device,
wherein the acknowledgement information is carried by radio resource control (RRC) and/or MAC CE and/or physical layer signaling.

In some embodiments, the network device transmits the acknowledgement information in a sl n,
wherein the activation/deactivation/switching/fallback of the AI/ML functionality/model is applied or taken into effect in a first slot after n+ΔT, where the ΔT is a predefined value or a configured value or depends on terminal capabilities.

In some embodiments, the ΔT also includes preparation time or interruption time required for the terminal equipment to perform functionality/model switching.

In some embodiments, the activation/deactivation/switching/fallback of the one or more AI/ML functionalities/models is determined by the network device, and the reporting information includes activation/deactivation/switching/fallback of one or more AI/ML functionalities/models selected or candidated or recommended or preferred by the terminal equipment.

In some embodiments, the terminal equipment receives acknowledgement information or command information fed back by the network device,
wherein the acknowledgement information or command information is carried by radio resource control (RRC) and/or a MAC CE and/or physical layer signaling.

In some embodiments, the terminal equipment transmits an ACK to the network device in a sl n,
wherein the activation/deactivation/switching/fallback of the AI/ML functionality/model is applied or taken into effect in a first slot after n+ΔT, where the ΔT is a predefined value or a configured value or depends on terminal capabilities.

In some embodiments, the ΔT also includes preparation time or interruption time required for the terminal equipment to perform functionality/model switching.

In some embodiments, the indication information or the reporting information includes activation/deactivation/switching/fallback for an AI/ML functionality and an AI/ML model; or
the indication information or the reporting information includes activation/deactivation/switching/fallback for an AI/ML functionality; or
the indication information or the reporting information includes activation/deactivation/switching/fallback for an AI/ML model.

The above embodiments only illustrate the disclosure. However, this disclosure is not limited thereto, and appropriate variants may be made on the basis of the above embodiments. For example, the above embodiments may be used alone, or one or more of the above embodiments may be combined together.

As can be seen from the above embodiments, the activation/deactivation/switching/fallback of the AI/ML functionality/model is agreed upon between the network device and the terminal equipment, thereby improving the accuracy and reliability of the AI/ML.

### Embodiments of a Third Aspect

The embodiments of this disclosure provide an AI/ML control apparatus, which may be, for example, a terminal equipment, or may be one or more components or assemblies configured in the terminal equipment. Same contents as those of the embodiments of the first and second aspects will not be described again.

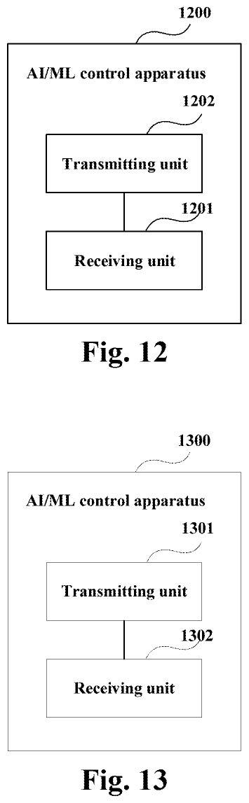

FIG. 12 is a schematic diagram illustrating an AI/ML control apparatus according to an embodiment of this disclosure. As illustrated in the FIG. 12, an AI/ML control apparatus 1200 according to an embodiment of this disclosure includes:
a receiving unit 1201 configured to receive indication information for indicating activation/deactivation/switching/fallback of an AI/ML functionality/model transmitted by a network device; and/or
a transmitting unit 1202 configured to report to the network device reporting information f determining activation/deactivation/switching/fallback of an AI/ML functionality/model.

In some embodiments, indication information including activation/deactivation/switching/fallback of one or more AI/ML functionalities/models is transmitted by the network device to a terminal equipment.

In some embodiments, the indication information is carried by a MAC CE.

In some embodiments, a set of AI/ML functionalities/models is configured by radio resource control (RRC), and the MAC CE indicates activation/deactivation/switching/fallback of one or more AI/ML functionalities/models in the configured set of AI/ML functionalities/models.

In some embodiments, the terminal equipment transmits an ACK corresponding to PDSCH to the network device in a slot n after receiving the PDSCH carrying the MAC CE.

In some embodiments, the activation/deactivation/switching/fallback of the AI/ML functionality/model is applied or taken into effect in a first slot after n+ΔT, where the ΔT is a predefined value or a configured value or depends on terminal capabilities; the ΔT also includes preparation time or interruption time required for the terminal equipment to perform functionality/model switching.

In some embodiments, the indication information is carried by downlink control information (DCI).

In some embodiments, the indication information is one field in the DCI, or an existing field in the DCI, or one or more codepoints in the DCI, or one DCI format, or DCI scrambled by one RNTI.

In some embodiments, the DCI is used to schedule PDSCH/PUSCH.

In some embodiments, the DCI is not used to schedule PDSCH/PUSCH.

In some embodiments, the DCI is used for one or more serving cells.

In some embodiments, the DCI is used for one or more terminal equipments.

In some embodiments, one or more fields in the DCI are used for validation; if the validation succeeds, the DCI is considered valid, or if the validation fails, the DCI is discarded.

In some embodiments, the terminal equipment transmits an ACK/NACK to indicate whether the DCI is correctly received to the network device after receiving the DCI.

In some embodiments, the terminal equipment transmits an ACK corresponding to the DCI in a slot n after correctly receiving the DCI.

In some embodiments, the activation/deactivation/switching/fallback of the AI/ML functionality/model is applied or taken into effect in a first slot after n+ΔT, where the ΔT is a predefined value or a configured value or depends on terminal capabilities; the ΔT also includes preparation time or interruption time required for the terminal equipment to perform functionality/model switching.

In some embodiments, a set of AI/ML functionalities/models is configured by radio resource control (RRC), one subset of the configured set of AI/ML functionalities/models is selected by a MAC CE, and the DCI indicates activation/deactivation/switching/fallback of one or more AI/ML functionalities/models in the selected subset.

In some embodiments, the subset is selected based on performance monitoring of the AI/ML functionality/model.

In some embodiments, a length of a field indicating the activation/deactivation/switching/ fallback of the AI/ML functionality/model in the DCI is determined by the number of AI/ML functionalities/models in the subset selected by the MAC CE.

In some embodiments, a set of AI/ML functionalities/models is configured by radio resource control (RRC), and the DCI indicates activation/deactivation/switching/fallback of one or more AI/ML functionalities/models in the configured AI/ML functionalities/models.

In some embodiments, a length of a field indicating the activation/deactivation/switching/fallback of the AI/ML functionality/model in the DCI is determined by the number of AI/ML functionalities/models configured by the RRC.

In some embodiments, the indication information is carried by radio resource control (RRC).

In some embodiments, reporting information including activation/deactivation/switching/fallback of one or more AI/ML functionalities/models is transmitted by the terminal equipment to the network device.

In some embodiments, the reporting information is carried by radio resource control (RRC) and/or a MAC CE and/or physical layer signaling.

In some embodiments, the activation/deactivation/switching/fallback of the one or more AI/ML functionalities/models is determined by the terminal equipment, and the reporting information includes the activation/deactivation/switching/fallback of the one or more AI/ML functionalities/models determined by the terminal equipment.

In some embodiments, the terminal equipment receives acknowledgement information fed back by the network device, wherein the acknowledgement information is carried by radio resource control (RRC) and/or a MAC CE and/or physical layer signaling.

In some embodiments, the network device transmits the acknowledgement information in a sl n.

In some embodiments, the activation/deactivation/switching/fallback of the AI/ML functionality/model is applied or taken into effect in a first slot after n+ΔT, where the ΔT is a predefined value or a configured value or depends on terminal capabilities; the ΔT also includes preparation time or interruption time required for the terminal equipment to perform functionality/model switching.

In some embodiments, the activation/deactivation/switching/fallback of the one or more AI/ML functionalities/models is determined by the network device, and the reporting information includes activation/deactivation/switching/fallback of one or more AI/ML functionalities/models selected, candidated, recommended or preferred by the terminal equipment.

In some embodiments, the terminal equipment receives acknowledgement information or command information fed back by the network device, wherein the acknowledgement information or command information is carried by radio resource control (RRC) and/or a MAC CE and/or physical layer signaling.

In some embodiments, the terminal equipment transmits an ACK to the network device in a sl n.

In some embodiments, the activation/deactivation/switching/fallback of the AI/ML functionality/model is applied or taken into effect in a first slot after n+ΔT, where the ΔT is a predefined value or a configured value or depends on terminal capabilities; the ΔT also includes preparation time or interruption time required for the terminal equipment to perform functionality/model switching.

In some embodiments, the indication information or the reporting information includes activation/deactivation/switching/fallback for an AI/ML functionality and an AI/ML model.

In some embodiments, the indication information or the reporting information includes activation/deactivation/switching/fallback for an AI/ML functionality.

In some embodiments, the indication information or the reporting information includes activation/deactivation/switching/fallback for an AI/ML model.

The above embodiments only illustrate the disclosure. However, this disclosure is not limited thereto, and appropriate variants may be made on the basis of the above embodiments. For example, the above embodiments may be used alone, or one or more of the above embodiments may be combined together.

It should be noted that the components or modules related to this disclosure are only describe above, however, this disclosure is not limited thereto. The AI/ML control apparatus 1200 may also include other components or modules. Refer to the related arts for the specific content of these components or modules.

In addition, for the sake of simplicity, the FIG. 12 only exemplifies a connection relationship or a signal direction of components or modules, however, those skilled in the art should appreciate that the related arts such as bus connections can be adopted. The components or modules can be implemented by hardware facilities, such as a processor, a memory, a transmitter, and a receiver, which is not limited in this disclosure.

As can be seen from the above embodiments, the activation/deactivation/switching/fallback of the AI/ML functionality/model is agreed upon between the network device and the terminal equipment, thereby improving the accuracy and reliability of the AI/ML.

### Embodiments of a Fourth Aspect

The embodiments of this disclosure provide an AI/ML control apparatus, which may be, for example, a network device, or may be one or more components or assemblies configured in the network device. Same contents as those of the embodiments of the first to third aspects will not be described again.

FIG. 13 is another schematic diagram illustrating the AI/ML control apparatus according to an embodiment of this disclosure. As illustrated in the FIG. 13, an AI/ML control apparatus 1300 includes:
a transmitting unit 1301 configured to transmit to a terminal equipment indication information for indicating activation/deactivation/switching/fallback of an AI/ML functionality/model; and/or
a receiving unit 1302 configured to receive reporting information for determining activation/deactivation/switching/fallback of an AI/ML functionality/model reported by the terminal equipment.

The above embodiments only illustrate the disclosure. However, this disclosure is not limited thereto, and appropriate variants may be made on the basis of the above embodiments. For example, the above embodiments may be used alone, or one or more of the above embodiments may be combined together.

It should be noted that the components or modules related to this disclosure are only describe above, however, this disclosure is not limited thereto. The AI/ML control apparatus 1300 may also include other components or modules. Refer to the related arts for the specific content of these components or modules.

In addition, for the sake of simplicity, the FIG. 13 only exemplifies a connection relationship or a signal direction of components or modules, however, those skilled in the art should appreciate that the related arts such as bus connections can be adopted. The components or modules can be implemented by hardware facilities, such as a processor, a memory, a transmitter, and a receiver, which is not limited in this disclosure.

As can be seen from the above embodiments, the activation/deactivation/switching/fallback of the AI/ML functionality/model is agreed upon between the network device and the terminal equipment, thereby improving the accuracy and reliability of the AI/ML.

### Embodiments of a Fifth Aspect

The embodiments of this disclosure also provide a communication system. Reference may be made to the FIG. 1. Same contents as those of the embodiments of the first to fourth aspects will not be described again.

In some embodiments, a communication system 100 may at least include:
a terminal equipment configured to receive indication information for indicating activation/deactivation/switching/fallback of an AI/ML functionality/model transmitted by a network device, and/or report to the network device reporting information for determining activation/deactivation/switching/fallback of an AI/ML functionality/model.

In some embodiments, the communication system 100 may at least include:
a network device configured to transmit to a terminal equipment indication information for indicating activation/deactivation/switching/fallback of an AI/ML functionality/model, and/or receive reporting information for determining activation/deactivation/switching/fallback of an AI/ML functionality/model reported by the terminal equipment.

The embodiments of this disclosure also provide a terminal equipment; however, this disclosure is not limited thereto, and other devices may also be involved.

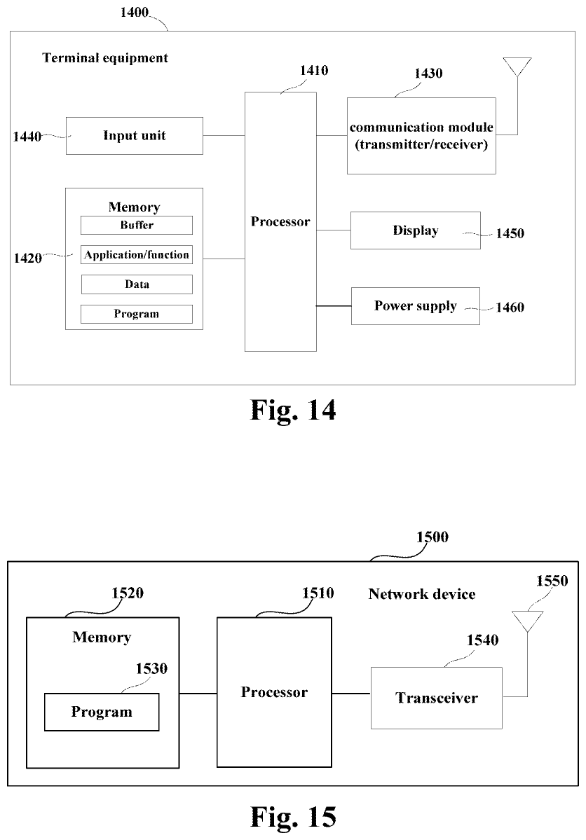

FIG. 14 is a schematic diagram illustrating a terminal equipment according to an embodiment of this disclosure. As illustrated in the FIG. 14, a terminal equipment 1400 may include a processor 1410 and a memory 1420 that stores data and a program and is coupled to the processor 1410. It should be noted that the figure is exemplary; and other types of structures may also be used to supplement or replace this structure, in order to implement telecommunication functions or other functions.

For example, the processor 1410 may be configured to execute a program to implement the AI/ML control method according to the embodiments of the first aspect. For example, the processor 1410 may be configured to receive indication information transmitted by a network device to indicate activation/deactivation/switching/fallback of an AI/ML functionality/model; and/or report to a network device reporting information for determining activation/deactivation/switching/fallback of an AI/ML functionality/model.

As illustrated in the FIG. 14, the terminal equipment 1400 may further include: a communication module 1430, an input unit 1440, a display 1450, and a power supply 1460, wherein the functions of the above components are similar to those in the relevant art and will not be described herein again. It should be noted that the terminal equipment 1400 does not necessarily include all the components illustrated in the FIG. 14, and the above components are not necessarily required. In addition, the terminal equipment 1400 may also include components not illustrated in the FIG. 14. Please refer to the relevant art.

The embodiments of this disclosure further provide a network device, which may be, for example, a base station, however, this disclosure is not limited thereto, and other network devices may also be involved.

FIG. 15 is a schematic diagram illustrating a network device according to an embodiment of this disclosure. As illustrated in the FIG. 15, a network device 1500 may include: a processor 1510 (such as a central processing unit (CPU)) and a memory 1520 coupled to the processor 1510. The memory 1520 may store various data. In addition, the memory 1520 may store a program 1530 for information processing, and the program 1530 may be executed under the control of the processor 1510.

For example, the processor 1510 may be configured to execute a program to implement the AI/ML control method according to the embodiments of the second aspect. For example, the processor 1510 may be configured to transmit to a terminal equipment indication information for indicating activation/deactivation/switching/fallback of an AI/ML functionality/model; and/or receive reporting information for determining activation/deactivation/switching/fallback of an AI/ML functionality/model reported by a terminal equipment.

In addition, as illustrated in the FIG. 15, the network device 1500 may further include: a transceiver 1540 and an antenna 1550, wherein the functions of the components are similar to those of the relevant art and will not be described herein again. It should be noted that the network device 1500 does not necessarily include all the components illustrated in the FIG. 15. In addition, the network device 1500 may also include components not illustrated in the FIG. 15. Please refer to the relevant art.

The embodiments of this disclosure also provide a computer program, wherein when the program is executed in a terminal equipment, the program enables the terminal equipment to perform the AI/ML control method according to the embodiments of the first aspect.

The embodiments of this disclosure also provide a storage medium storing a computer program, wherein the computer program enables a terminal equipment to perform the AI/ML control method according to the embodiments of the first aspect.

The embodiments of this disclosure also provide a computer program, wherein when the program is executed in a network device, the program enables the network device to perform the AI/ML control method according to the embodiments of the second aspect.

The embodiments of this disclosure also provide a storage medium storing a computer program, wherein the computer program enables a network device to perform the AI/ML control method according to the embodiments of the second aspect.

The above apparatus and method of this disclosure can be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a magnetic disk, a CD, a DVD, a flash memory, etc.

The method/apparatus described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. These software modules may respectively correspond to the steps shown in the drawings. And these hardware modules, for example, may be carried out by firming these software modules by using a field programmable gate array (FPGA).

The software modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information to the memory medium; or the memory medium may be a component of the processor. The processor and the memory medium may be located in an ASIC. The software modules may be stored in a memory of a mobile terminal and may also be stored in a memory card of a pluggable mobile terminal. For example, if equipment (such as a mobile terminal) employs an MEGA-SIM card of a relatively large capacity or a flash memory device of a large capacity, the software modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this disclosure. And the one or more functional block diagrams and/or one or more combinations of the functional block diagrams in the drawings may also be realized as a combination of computing equipment, such as a combination of a DSP and a microprocessor, multiple microprocessors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and amendments to this disclosure may be made by those skilled in the art according to the spirit and principle of this disclosure, and such variants and amendments also fall within the scope of this disclosure.

As to implementations containing the above embodiments, supplements are further disclosed below:
1. An AI/ML control method, including:
receiving, by a terminal equipment, indication information for indicating activation/deactivation/switching/fallback of an AI/ML functionality/model transmitted by a network device; and/or
reporting, by a terminal equipment, to a network device reporting information for determining activation/deactivation/switching/fallback of an AI/ML functionality/model.
2. An AI/ML control method, including:
transmitting, by a network device, to a terminal equipment indication information for indicating activation/deactivation/switching/fallback of an AI/ML functionality/model; and/or
receiving, by a network device, reporting information for determining activation/deactivation/switching/fallback of an AI/ML functionality/model reported by a terminal equipment.
3. A terminal equipment, including: a memory configured to store a computer program and a processor configured to execute the computer program to implement the AI/ML control method according to supplement 1.
4. A network device, including: a memory configured to store a computer program and a processor configured to execute the computer program to implement the AI/ML control method according to supplement 2.
5. A communication system, including:
a network device configured to transmit to a terminal equipment indication information for indicating activation/deactivation/switching/fallback of an AI/ML functionality/model, and/or receive reporting information for determining activation/deactivation/switching/fallback of an AI/ML functionality/model reported by the terminal equipment.

1. An AI/ML control apparatus, configured in a terminal equipment, the apparatus comprising:
a transmitter configured to report information on one or more applicable or preferred or selected or candidate or recommend AI/ML functionalities/models to a network device via a radio resource control (RRC) message,
wherein the radio resource control (RRC) message is a RRC reconfiguration complete message or a UE assistance information (UAI) message.

2. The apparatus according to claim 1, further comprising:
processor circuitry configured to determine the one or more applicable or preferred or selected or candidate or recommend AI/ML functionalities/models based on event-triggering, or based on functionality/model performance monitoring/assessment, or based on condition changing.

3. The apparatus according to claim 1, further comprising:
a receiver configured to receive indication information for indicating activation/deactivation/switch/fallback of an AI/ML functionality/model transmitted by the network device.

4. The apparatus according to claim 1, wherein the information on one or more applicable or preferred or selected or candidate or recommend AI/ML functionalities/models is included in the RRC reconfiguration complete message, and a report of the information on one or more applicable or preferred or selected or candidate or recommend AI/ML functionalities/models is triggered by the network device.

5. The apparatus according to claim 1, wherein the information on one or more applicable or preferred or selected or candidate or recommend AI/ML functionalities/models is included in the UE assistance information (UAI) message, and a report of the information on one or more applicable or preferred or selected or candidate or recommend AI/ML functionalities/models is initiated by the terminal equipment.

6. The apparatus according to claim 1, wherein the transmitter is further configured to report reporting information for determining activation/deactivation/switch/fallback of one or more AI/ML functionalities/models.

7. The apparatus according to claim 6, further comprising:
a receiver configured to receive acknowledgement information fed back by the network device, wherein the acknowledgement information is carried by radio resource control and/or MAC (media access control) CE (control element) and/or physical layer signaling and is carried in a slot n;
wherein the activation/deactivation/switch/fallback of the one or more AI/ML functionalities/models is applied or taken into effect in a first slot after n+ΔT, ΔT is a predefined value or a configured value or is depend on a terminal capability; and ΔT further comprises preparation time or interruption time required by the terminal equipment to perform a functionality/model switch.

8. The apparatus according to claim 6, wherein the activation/deactivation/switch/fallback of the one or more AI/ML functionalities/models is determined by the network device, and the reporting information includes the activation/deactivation/switch/fallback of the one or more AI/ML functionalities/models selected or candidate or recommended or preferred by the terminal equipment.

9. The apparatus according to claim 3, wherein indication information comprising activation/deactivation/switching/fallback of one or more AI/ML functionalities/models is transmitted by the network device to a terminal equipment.

10. The apparatus according to claim 9, wherein the indication information is carried by a MAC CE,
and a set of AI/ML functionalities/models is configured by radio resource control, and the MAC CE indicates activation/deactivation/switching/fallback of one or more AI/ML functionalities/models in the set of AI/ML functionalities/models that is configured.

11. The apparatus according to claim 10, wherein the terminal equipment transmits an ACK corresponding to a PDSCH (physical downlink shared channel) to the network device in a slot n after receiving the PDSCH carrying the MAC CE,
wherein the activation/deactivation/switching/fallback of the AI/ML functionality/model is applied or taken into effect in a first slot after n+ΔT, where the ΔT is a predefined value or a configured value or is dependent on terminal capabilities, and the ΔT further comprises preparation time or interruption time required for the terminal equipment to perform functionality/model switching.

12. The apparatus according to claim 9, wherein the indication information is carried by downlink control information, and
the indication information is one field in the downlink control information, or an existing field in the downlink control information, or one or more codepoints in the downlink control information, or one downlink control information format, or downlink control information scrambled by one RNTI.

13. The apparatus according to claim 12, wherein the downlink control information is used to schedule a PDSCH/PUSCH (physical uplink shared channel), or the downlink control information is not used to schedule a PDSCH/PUSCH,
the downlink control information is used for one or more serving cells, and
the downlink control information is used for one or more terminal equipments.

14. The apparatus according to claim 12, wherein one or more fields in the downlink control information are used for validation, and in a case where the validation succeeds, the downlink control information is considered to be valid, or in a case where the validation fails, the downlink control information is discarded.

15. The apparatus according to claim 12, wherein a terminal equipment transmits to the network device an ACK/NACK for indicating whether the downlink control information is correctly received, after receiving the downlink control information.

16. The apparatus according to claim 12, wherein a terminal equipment transmits an ACK corresponding to the downlink control information in a slot n after correctly receiving the downlink control information,
wherein the activation/deactivation/switching/fallback of the AI/ML functionality/model is applied or taken into effect in a first slot after n+ΔT, where the ΔT is a predefined value or a configured value or is dependent on terminal capabilities, and the ΔT further comprises preparation time or interruption time required for the terminal equipment to perform functionality/model switching.

17. The apparatus according to claim 12, wherein a set of AI/ML functionalities/models is configured by radio resource control, one subset of the set of AI/ML functionalities/models that is configured is selected by a MAC CE, and the downlink control information indicates activation/deactivation/switching/fallback of one or more AI/ML functionalities/models in the subset that is selected;
the subset is selected according to performance monitoring of AI/ML functionalities/models; and
a length of a field indicating the activation/deactivation/switching/fallback of the AI/ML functionality/model in the downlink control information is determined by the number of the AI/ML functionalities/models in the subset selected by the MAC CE.

18. The apparatus according to claim 12, wherein a set of AI/ML functionalities/models is configured by radio resource control, and the downlink control information indicates activation/deactivation/switching/fallback of one or more AI/ML functionalities/models in the AI/ML functionalities/models that is configured; and
a length of a field indicating the activation/deactivation/switching/fallback of the AI/ML functionality/model in the downlink control information is determined by the number of the AI/ML functionalities/models configured by the radio resource control.

19. An AI/ML control apparatus, configured in a network device, the apparatus comprising:
a receiver configured to receive information on one or more applicable or preferred or selected or candidate or recommend AI/ML functionalities/models reported by a terminal equipment via a radio resource control (RRC) message;
wherein the radio resource control (RRC) message is a RRC reconfiguration complete message or a UE assistance information (UAI) message.

20. A communication system, comprising:
a terminal equipment configured to report information on one or more applicable or preferred or selected or candidate or recommend AI/ML functionalities/models to a network device via a radio resource control (RRC) message,
wherein the radio resource control (RRC) message is a RRC reconfiguration complete message or a UE assistance information (UAI) message.
